(19) United States
(12) Patent Application Publication
(10) Pub. No.: US 2010/0264744 A1
(43) Pub. Date: Oct. 21, 2010

(54) Solar Inverter Having a Plurality of Individual Inverters Connected In Parallel And Having a Primary Electronic Control Unit

(76) Inventors: Sebastian Schmitt, Forchheim (DE); Jens Weidauer, Hochstadt (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/743,131

(22) PCT Filed: Oct. 2, 2008
(86) PCT No.: PCT/EP2008/063200

§ 371 Date: May 24, 2010

(30) Foreign Application Priority Data
Nov. 15, 2007 (DE) 10 2007 054 647.7

(51) Int. Cl. H02J 3/00

(52) U.S. Cl. 307/82

(57) ABSTRACT

A solar inverter comprising a plurality of individual inverters connected in parallel and each having a power unit for converting a field voltage on the input side into a mains voltage on the output side, and having a primary electronic control unit that is configured to perform all primary control functions and control functions that can be associated with the individual inverters.

### CROSS-REFERENCE TO RELATED APPLICATIONS

This is a U.S. national stage of International Application No. PCT/EP2008/063200, filed on 2 Oct. 2008. Priority is claimed on German Application No. 10 2007 054 647.7, filed on 15 Nov. 2007.

### BACKGROUND OF THE INVENTION

1. Field of the Invention

The invention relates to a solar inverter and more particularly, to a solar inverter having a plurality of individual inverters connected in parallel, each having a power unit for converting a field voltage on the input side into a mains voltage on the output side and having a primary electronic control unit.

2. Description of the Related Art

Conventional solar inverters convert the direct voltage provided by a solar field or by one or more solar modules into an alternating voltage. On the output side, the solar inverter can, for example, feed into an energy supply company's single-phase 50 Hz/230V power supply network or 60 Hz/120V power supply network. Preferably, three-phase inverters which feed into an appropriate three-phase power supply network, such as a 50 Hz/400V power supply network are used for large solar fields. A plurality of solar inverters can also be connected to a common bus bar into which the solar field or the solar modules feed.

Generally, solar inverters which are connected to a solar field on the input side have a plurality of individual inverters connected in parallel that are switched-in individually as the intensity of the solar radiation increases. When all individual inverters are connected, a maximum electrical power can be fed back into the power supply network. The step-by-step connection improves the efficiency of the overall solar inverter or of the overall photovoltaic system for lower values of incident radiation.

In addition to a power unit, each individual inverter has its own regulation electronics unit in which the inverter functions, such as control of the power semiconductors, current and voltage regulation or protective function and monitoring, are realized for the respective individual inverter. A primary controller, i.e., an electronic control unit, undertakes the coordination of the overall solar inverter and, amongst other things, switches the individual inverters on and off depending on the system operating state. The electronic control unit also provides the setpoints for the individual inverters, i.e., a mains voltage or a mains current. The necessary regulation and control functions of the solar inverter are processed and distributed between various electronic assemblies. The respective individual inverters are connected together for exchanging data. Usually, the regulation electronics units of the individual inverters are connected to the primary control unit by a communications bus. This bus connection can be a parallel or serial bus, for example. Alternatively or additionally, the data or signal exchange between the respective individual inverters and the primary electronic control unit can be performed by digital or analog signal cables.

A disadvantage with conventional solar inverters described is the complex programming of the plurality of regulation electronics units and of the primary electronic control unit. This complexity requires the use of different programming tools which are tailored to the primary control unit and the regulation electronics units of the individual invertors, respectively. A further disadvantage is the complex data storage and archiving of the source and object files, and the associated change management of the developed software. A further disadvantage is the elaborate fault finding if the individual inverter in one of the regulation electronics units should be faulty.

### SUMMARY OF THE INVENTION

It is therefore an object of the invention to provide a modular solar inverter having a plurality of individual inverters which no longer has the above-mentioned disadvantages.

This and other objects and advantages are achieved in accordance with the invention with a solar inverter in which the electronic control unit is configured to perform all primary regulation and control functions, as well as those that can be associated with the respective individual inverters.

Configuring the solar inverter in this manner provides a major advantage in that, instead of a plurality of regulation electronics units in the individual inverters and the primary electronic control unit, only one (i.e., a single) central control and regulation unit is used which undertakes all regulation and control functions of the solar inverter which is comprised of a plurality of individual inverters. In other words, regulation is no longer performed in the respective individual inverters. This has the further advantage that the individual inverters no longer have to be configurable and consequently can be designed as a “black box”.

Furthermore, the configuration in accordance with the invention of the solar inverter advantageously leads to a simplified assembly and to a lower total current consumption due to the presence of only one single central control and regulation unit. A further advantage is the higher reliability, because only one single electronic control unit is present. This advantageously reduces the hardware costs, as well as the development and project engineering costs for the overall solar inverter. In addition, the commissioning of the solar inverter in accordance with the invention and the time required for fault finding in the solar inverter are simplified due to the greatly reduced number of possible fault sources.

In an embodiment, the electronic control unit and all individual inverters are connected together by a communications bus, such as a serial or a parallel communications bus i.e., a CAN-bus, a field bus or a “DRIVE-CLiQ”.

In accordance with an embodiment of the invention, the electronic control unit includes a first device for regulating the mains current and for primary regulation of the mains voltage for each individual inverter. Here, the individual inverters each include a current measuring device and a voltage measuring device for measuring an actual value of the mains current and an actual value of the mains voltage. The individual inverters and each include a signal conditioning unit for signal conditioning and onward transmission of the measured actual values to the control unit. Additionally, the individual inverters each include the signal conditioning unit for converting a respective mains current setpoint supplies from the control unit and a respective mains voltage setpoint into a corresponding pulse sequence for controlling switching elements of the respective power unit.

The signal conditioning unit of each individual inverter simultaneously serves (exclusively) to convert the respective current setpoint or voltage setpoint into the respective appropriate pulse sequence for controlling the power semiconductors without affecting the regulator. Advantageously, the signal processing unit reproduces the respective setpoint, which is transmitted in the form of data words, in appropriate binary signal sequences in accordance with an algorithm stored in a program memory of the signal processing unit. Alternatively, the transmitted data words can address a fixed value memory in the signal processing unit which then provides a plurality of corresponding binary pulse values. Preferably, the binary pulse values represent an on/off ratio of the respective switching element to be controlled corresponding to the respective setpoint. The binary pulse values are cyclically repeated as binary signal sequences for generating the single or poly-phase mains voltage on the output side. The binary signal sequences can be raised by downstream drivers or amplifiers to a voltage level necessary for controlling the switching elements, which are preferably based on semiconductors.

In the reverse direction, the signal conditioning unit serves to digitize the measured analog actual values of current and voltage and to output these as data words to the central control and regulation unit over the communications bus. An analog/digital converter is preferably used for digitizing.

In accordance with an alternative embodiment, the electronic control unit includes a second device for regulation of the mains current and for primary regulation of the mains voltage, and for regulation of the phase current and regulation of the phase voltage of the individual inverters for each individual inverter. The solar inverters each include a current measuring device and a voltage measuring device for measuring an actual value of the mains current and an actual value of the mains voltage, as well as at least one phase current measuring device and at least one phase voltage measuring device for measuring respective actual values of phase current and respective actual values of phase voltage. The individual inverters each include a signal processing unit for signal conditioning and onward transmission of the measured actual values to the control unit. The second device of the electronic control unit then converts the conditioned actual values in a control loop into a corresponding pulse sequence for controlling switching elements of the respective power unit.

In comparison with the previous embodiment, the function of the signal conditioning unit of the presently contemplated embodiment is restricted in that the digitally coded control pulses, which are preferably transmitted over the communications bus, are converted directly into binary control pulses for the respective switching elements.

In the simplest case, two data bits per inverter phase, which correspond to the binary switching states of the switching elements associated with a respective phase, are transmitted continuously.

On the reverse path, all actual values of voltage and current measured by the current and voltage measuring devices are digitized. The corresponding digitally coded actual values are output to the communications bus as data words.

In alternative embodiments in which the current and voltage measuring devices already provide the measured actual values of current and voltage digitally, the signal conditioning unit is configured to output the pre-digitized actual values to the communications bus in accordance with a defined bus protocol.

In particular, the electronic control unit includes a multitasking and/or real-time operating system. This guarantees that a plurality of parallel individual inverters can be controlled reliably. The operating system is preferably configured such that a plurality of modular individual inverters in installation slots provided for this purpose can automatically be incorporated and operated in the solar inverter from a control and regulation aspect.

In accordance with a further embodiment, the individual inverters each have a switching device on the input side for switching the respective individual inverter to the field voltage and/or a switching device on the output side for switching the respective individual inverter to the mains voltage. The electronic control unit is connected to the switching device for individually controlling the switching device. This has the advantage that an appropriate number of individual inverters can be switched on or off depending on the intensity of the incident radiation. As a result, the overall efficiency of the solar inverter is increased. Preferably, the switching device is a relay or a contactor.

In particular, the individual inverters each include a three-phase power unit for converting the field voltage on the input side into a three-phase mains voltage on the output side. The signal conditioning units are configured for the three-phase case in a corresponding manner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and advantageous embodiments of the invention are described in more detail below with reference to the following, in which:

FIG. 1 shows an exemplary schematic block diagram of solar inverter having three individual inverters each with a regulation electronics unit and a principal control unit in accordance with the invention;

FIG. 2 shows an exemplary solar inverter in accordance with the invention including three individual inverters and a principal central control and regulation unit;

FIG. 3 shows an exemplary schematic block circuit diagram of a signal conditioning unit in accordance with an embodiment of the invention;

FIG. 4 shows an exemplary schematic block circuit diagram of a signal conditioning unit in accordance with another embodiment of the invention; and

FIG. 5 shows a schematic block circuit diagram of an exemplary individual inverter with a signal conditioning unit and with a power unit in accordance with the invention.

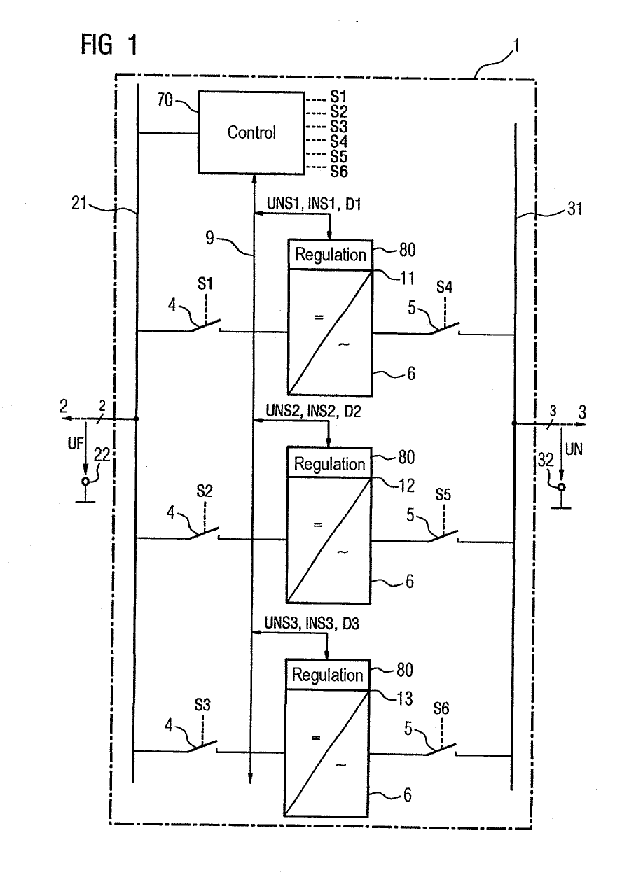

FIG. 1 shows an exemplary solar inverter 1 having, for example, three individual inverters 11-13 connected in parallel, each having a power unit 6 for converting a field voltage UF on the input side into a mains voltage UN on the output side and having a primary electronic control unit 70.

The respective individual inverters 11-13 are individually switchable by a switching device 4 on the input side to direct voltage cables 21 which are connected to a solar field 2 or to one or more solar modules. A field or link circuit voltage comprising a first reference potential 22 is designated by UF. Furthermore, the respective individual inverters 11-13 are individually connectable to a power supply network 3 by another switching device 5 on the output side. By way of example, the switching devices 4, 5, shown are relays. Control signals for controlling the switching devices 4, 5 which are output by the principal control unit 70 are designated by S1-S6. The individual inverters 11-13 can be selectively switched on and off by the control signals S1-S6 depending on the incident solar radiation.

In the presently contemplated embodiment, the supply is three-phase. In alternative embodiments, the supply is single-phase. Corresponding mains supply cables are designated by reference numeral 31. A three-phase mains voltage, which is referred to a second reference potential 32 such as ground potential, is designated by UN. The electronic control unit 70 is connected to the respective regulation electronics units 80 of the individual inverters 11-13 by a communications bus 9, for example, for exchanging data. The electronic control unit 70 provides a respective mains voltage setpoint UNS1-UNS3 or a respective mains current setpoint INS1-INS3 to the respective regulation electronics units 80 over the communications bus 9, either for primary voltage regulation or for primary current regulation. Further data, such as diagnostics data, are designated by D1-D3. Among other things, these are used for monitoring or for determining the status of the individual inverters 11-13.

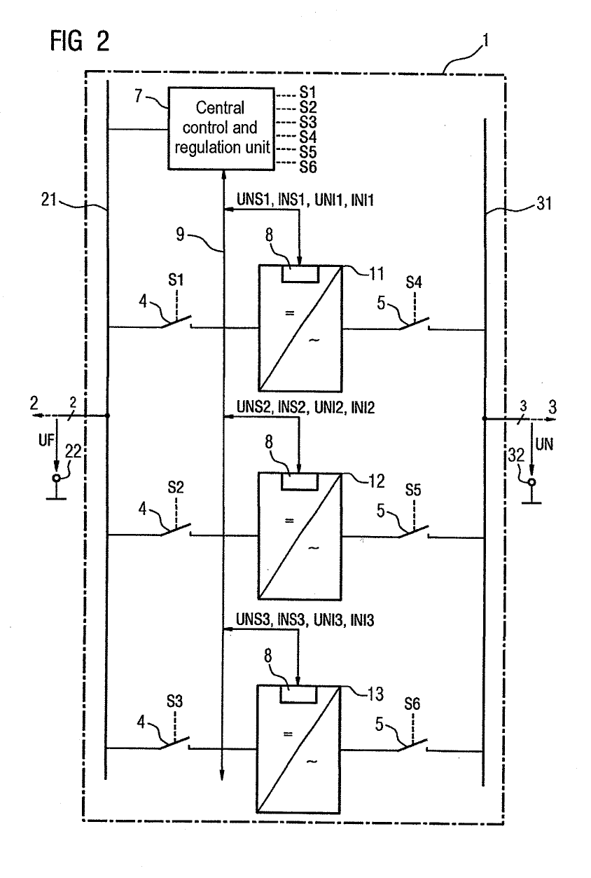

FIG. 2 shows a block circuit diagram of a solar inverter 1 in accordance with an exemplary embodiment of the invention which, by way of example, includes three individual inverters 11-13 and an electronic control unit comprising a primary central control and regulation unit 7.

Here, the electronic control unit 7 includes a first device, which is not shown in more detail, for primary regulation of the mains current or primary regulation of the mains voltage for each individual inverter 11-13. The electronic control unit is connected to all individual inverters 11-13 by a communications bus 9. Data transmission can be parallel or serial. The control unit 7 outputs a respective mains current setpoint INS1-INS3 or a respective mains voltage setpoint UNS1-UNS3 to a respective signal conditioning unit 8 of the individual inverters 11-13 over this communications bus 9. On the reverse path, the respective signal conditioning unit 8 outputs corresponding actual values of the mains voltage UNI1-UNI3 which are measured in the respective individual inverter 11-13 and actual values of the mains current INI1-INI3 which are measured therein to the communications bus 9 for regulation feedback to the electronic control unit 7.

The electronic control unit 7 preferably includes a multitasking and/or real-time operating system for the principal control and regulation of the individual inverters 11-13. This enables reliable operation and simple expansion of the solar inverter 1 in accordance with the contemplated embodiments of the invention by the addition of further individual inverters 11-13.

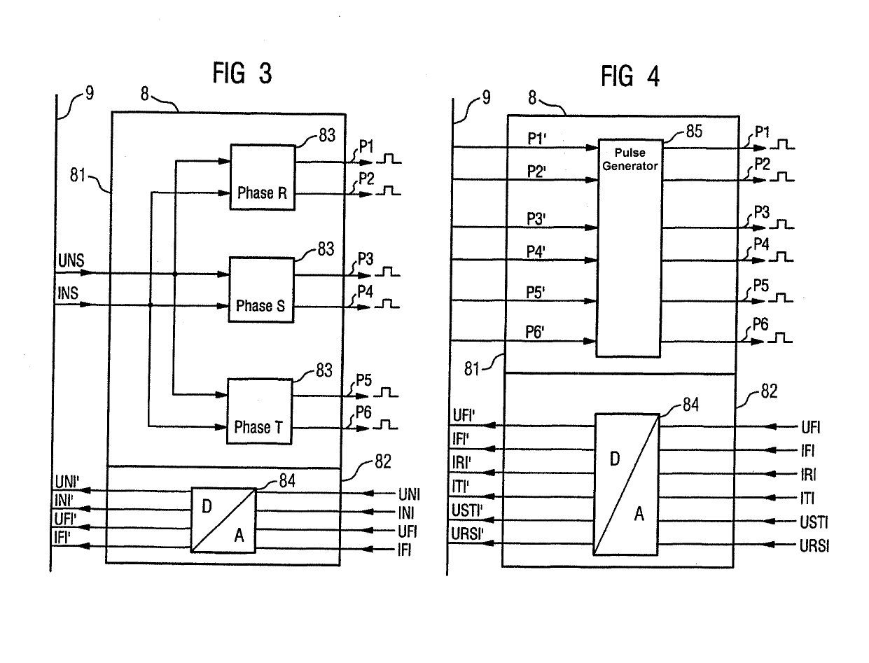

FIG. 3 shows an exemplary schematic block circuit diagram of a signal conditioning unit 8 in accordance with an embodiment of the invention.

The signal conditioning unit 8 shown serves to convert a respective mains current setpoint INS or a respective mains voltage setpoint UNS supplied from the control unit 7 over the communications bus 9 into a corresponding pulse sequence P1-P6 for controlling switching elements of the respective power unit. In the exemplary embodiment of FIG. 3, the conversion is three-phase, a dedicated pulse generator 83 being provided for each network phase.

In the exemplary embodiment of FIG. 3, the processing of the respective mains current setpoint INS or mains voltage setpoint UNS is combined in a sub-unit 81 of the signal conditioning unit 8. A second sub-unit 82 of the signal conditioning unit 8 is shown in the bottom part of FIG. 3. This second sub-unit 82 is used for signal conditioning and onward transmission of the measured actual values INI, UNI to the control unit 7. The values INI, UNI are, in turn, output to the communications bus 9. In particular, the signal conditioning unit includes an analog/digital converter 84 which digitizes the actual values INI, UNI which are normally supplied in analog form, and outputs them to the communications bus 9 as digitally coded values INI′, UNI′.

In addition, as shown in the exemplary embodiment of FIG. 3, respectively measured actual values of field voltage UFI and/or actual values of field current IFI can be converted by the analog/digital converter 84 into corresponding digitally coded values UFI′, IFI′, in particular for protection purposes.

FIG. 4 shows a block circuit diagram of a signal conditioning unit 8 in accordance with another embodiment of the invention.

In the example exemplary embodiment of FIG. 4, the signal conditioning unit 8 includes a further pulse generator 85 which converts the digitally coded control signals P1′-P6′ transmitted from the central control and regulation unit 7 over the communications bus 9 into corresponding control signals P1-P6, in particular for direct control of the switching elements of the power unit. In this way, for example, the six digitally coded control signals P1′-P6′ shown can be transmitted over the communications bus 9 as a data word, where one bit of this data word represents the corresponding switching state of a switching element. A logic “1” of the appropriate bit, for example, can therefore represent a positive control signal for use in controlling the switching element, while a logic “0” of this data word represents a blocking signal for use in controlling the switching device.

A second sub-unit 82 of the signal conditioning unit 8 for transmitting the actual values UFI, IFI, IRI, ITI, USTI, URSI is in turn shown in the bottom part of FIG. 4. An analog/digital converter which, as well as an actual value of field voltage UFI and an actual value of field current IFI, also digitizes two actual values of phase current IRI, ITI and two actual values of phase voltage, USTI, URSI, is designated by reference numeral 84. The signal processing unit 8 converts, these actual values of the phase voltage USTI, URSI into digitally coded actual values UFI′, IFI′, IRI′, ITI′, USTI′, URSI′ which are “suitable for the bus” for onward transmission to the communications bus 9. In the exemplary embodiment of FIG. 4, only two actual values of phase current IRI, ITI and two actual values of phase voltage USTI, URSI are digitized. The remaining third phase quantities are each calculated from the first two.

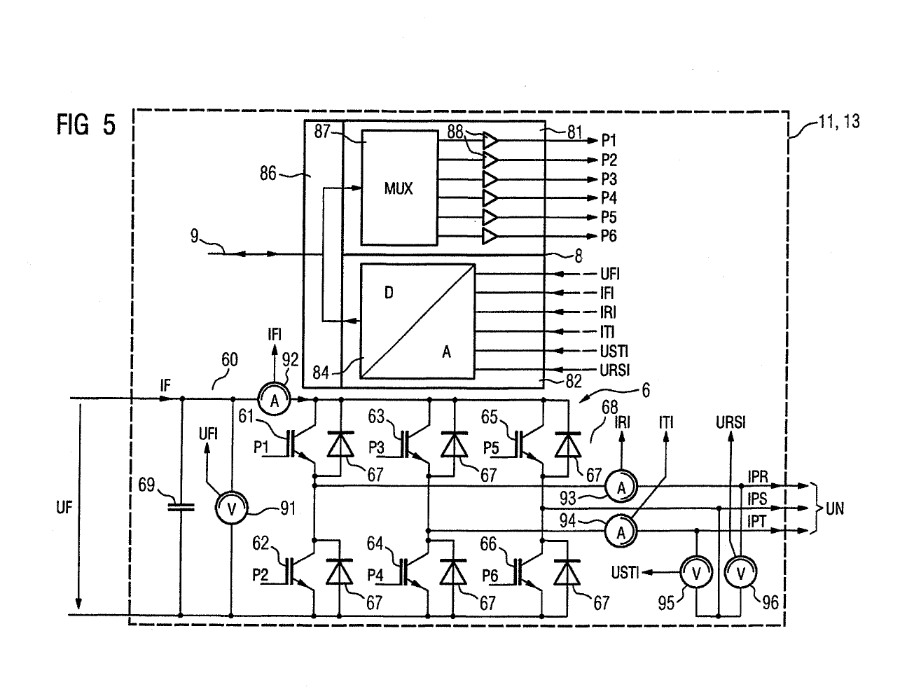

An exemplary schematic block circuit diagram of an individual inverter 11-13 in accordance with the invention is shown in FIG. 5. The signal conditioning unit 8 is shown in the top part of FIG. 5, and the block diagram of the associated power unit 6 is shown in the bottom part of FIG. 5. In the left-hand part of FIG. 5, the power unit 6 includes a voltage link circuit designated by reference numeral 60. The field voltage UF is applied to this voltage link circuit 60. Consequently, the field voltage UF can also be described as the link circuit voltage. The field current flowing into the link circuit 60 is designated by the reference IF. The link circuit 60 is provided with a link circuit capacitor 69 to buffer the input voltage UF. A voltage measuring device 91 is provided for measuring the link circuit voltage or the field voltage UF. This outputs a corresponding actual value of field voltage UFI to the signal conditioning unit 8. Furthermore, a current measuring device 92 is provided in the link circuit 60 which is used to measure the field current IF and outputs a corresponding actual value IFI to the signal conditioning unit 8.

A three-phase inverter unit 68 is shown in the bottom right-hand part of FIG. 5. By appropriate control of its respective switching elements 61-66, the three-phase inverter unit 68 converts the applied link circuit voltage UF into a three-phase mains voltage UN. In the exemplary embodiment shown in FIG. 5, the switching elements 61-66 are semiconductor switches. The semiconductor switches 61-66 shown are Insulated Gate Bipolar Transistors (IGBT). A freewheel diode 67 is connected anti-parallel with the respective transistors 61-66. Two phase current measuring devices 93, 94 are provided for measuring the phase currents IPR, IPS, IPT on the output side. The missing phase current IPS can be derived from the two phase currents IPR, IPT already measured. The corresponding actual values of phase current IRI, ITI supplied fed to the associated signal conditioning unit 8. Two phase voltage measuring devices 95, 96 are provided for measuring the phase voltages. The remaining phase voltage can likewise be derived from the phase voltages already measured. The corresponding actual values of phase voltage USTI, URSI are supplied to the signal conditioning unit 8.

The signal conditioning unit 8 additionally includes a bus activation circuit 86 which converts the data traffic from and to the communications bus 9 into appropriate binary data for further processing in the signal conditioning unit 8. By way of example, a multiplexer which converts the binary information originating from a data word of the communications bus 9 into parallel individual signals is designated by the reference numeral 87. Amplifiers which convert the corresponding signals P1-P6 to the necessary voltage level for controlling the semiconductor elements 61-66 are designated by the reference 88. The analog/digital conversion of the actual values UFI, IFI, IRI, ITI, USTI, URSI into corresponding data for transmission over the communications bus 9 is in turn performed in the bottom part of the signal conditioning unit 8.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A solar inverter, comprising:
a plurality of individual inverters connected in parallel, each of said plural convertors having a power unit configured to convert a field voltage on an input side into a mains voltage on an output side; and
a primary electronic control unit configured to perform all primary regulation and control functions for the solar inverter and individual regulation and control functions associated with each of said plural individual inverters.

9. The solar inverter as claimed in claim 8, wherein
the electronic control unit includes a first device for one of primary regulation of mains current and regulation of mains voltage for each of said plural individual inverters;
each of said plural individual inverters includes a current measuring device and a voltage measuring device for measuring an actual value of the mains current and an actual value of the mains voltage; and
wherein each of said plural individual inverters includes a signal conditioning unit for signal conditioning and onward transmission of the measured actual values of the mains current and the mains voltage to the electronic control unit, and for converting a respective mains current setpoint supplied from one of the electronic control unit and a respective mains voltage setpoint into a corresponding pulse sequence for controlling switching elements of respective power units of each of said plural individual inverters.

10. The solar inverter as claimed in claim 8, wherein
the electronic control unit includes a first device for one of primary regulation of mains current and primary regulation of mains voltage, and for regulation of a phase current and regulation of a phase voltage of each of said plural individual inverters;
each of said plural individual inverters includes a current measuring device and a voltage measuring device for measuring an actual value of field current and an actual value of field voltage, and at least one phase current measuring device and at least one phase voltage measuring device in each case for measuring respective actual values of the phase current and respective actual values of the phase voltage;
each of said plural individual inverters includes a signal conditioning unit for signal conditioning and onward transmission of the measured actual values of the field current, the field voltage, the phase current and the phase voltage to the electronic control unit, and
wherein the second device of the electronic control unit converts the conditioned actual field current, field voltage, phase current and phase voltage values into a corresponding pulse sequence for controlling switching elements of respective power units of each of said plural individual invertors.

11. The solar inverter as claimed in claim 8, wherein the electronic control unit and all of said plural individual inverters are connected together by a communications bus.

12. The solar inverter as claimed in claim 8, wherein the electronic control unit includes at least one of a multitasking and real-time operating system.

13. The solar inverter as claimed in claim 8, wherein
each respective one of said plural individual inverters includes at least one of a first switching device on the input side configured to switch said respective individual inverter to the field voltage and a second switching device on the output side configured to switch said respective individual inverter to the mains voltage; and
wherein the electronic control unit is connected to the first and second switching device for individually controlling the first and second switching devices.

14. The solar inverter as claimed in claim 8, wherein each of said plural individual inverters includes one of a single-phase and three-phase power unit configured to convert the field voltage on the input side into one of a single-phase and three-phase mains voltage on the output side.

15. The solar inverter as claimed in claim 8, wherein the input sides of each of said plural individual inverters are connected to cables connected or connectable to a solar field or solar modules.
